(19) United States
(12) Patent Application Publication
(10) Pub. No.: US 2014/0102961 A1
(43) Pub. Date: Apr. 17, 2014

(54) DRAINING DEVICE FOR FOOD STUFFS

(71) Applicant: Nicholas G. Verveniotis, Darian, IL (US)

(72) Inventor: Nicholas G. Verveniotis, Darian, IL (US)

(21) Appl. No.: 13/946,057

(22) Filed: Jul. 19, 2013

Related U.S. Application Data
(60) Provisional application No. 61/741,609, filed on Jul. 24, 2012.

(51) Int. Cl. A23C 9/12; A01J 25/11

(52) U.S. Cl. CPC A23C 9/1226; A01J 25/117
USPC 210/91; 210/474

(57) ABSTRACT

A multi-component apparatus reduces the moisture content of thickened, coagulated, or curdled food stuffs. The food stuffs rest upon a slotted tray, and gravity forces the excess moisture through the openings of the tray, a center filter, a disk screen, and into a collection cup. The disk screen has a solid surface that lines up with the openings in the tray and is raised and lowered using attached slide latches, dependent on the latch position. When the latches are positioned to the open position, the fluid is allowed to flow through into the attached collection cup and allows for the collection cup to be removed for draining and complete cleaning. The filter may be inside the tray or between the tray and the disk screen. A cover may be placed on the tray either during or following the filtration process to store the food product.

### CROSS-REFERENCE TO RELATED APPLICATION

This application claims the benefit of priority of U.S. provisional application No. 61/741,609, filed Jul. 24, 2012, the contents of which are herein incorporated by reference.

### BACKGROUND OF THE INVENTION

The present invention is generally in the field of food preparation. More specifically, the present invention is an apparatus for reducing the moisture content of thickened, coagulated or curdled food stuffs, such as yogurt and tofu. The process generates a resultant product that enables food preparers to substantially change the viscosity, texture, quality, and taste of their dish.

Yogurts and cottage cheese naturally separate into a heterogeneous mixture that leaves a solid in a pool of liquid whey. Removing excess liquid whey typically makes the resultant mixture richer, creamier, and thicker. This technique is often applied when a yogurt is to be utilized as a dessert topping, to appease the tastes of consumers preferring a more “Greek” yogurt texture, or to generate a less “soupy” form of cottage cheese.

The traditional method for the removal of liquid whey involves folding several layers of cheesecloth, or a similar woven material, to form a filter. The whey slowly drains and the remaining solid residue remains on the cloth filter. However, this process results in having to thoroughly launder or discard the filter cloth, and the resultant mixture is often devoid of calcium from the residue stuck within the cloth.

Tofu is packaged in liquid, and thus it is purchased in blocks that are very high in moisture content. The packaged liquid is generally regarded to be of poor taste, and many recipes require a firm tofu that is free of excess moisture. Also, a firm, or “pressed,” tofu substantially changes the taste and texture of the purchased tofu. This enables the food preparer to marinate the tofu in a liquid conducive to the taste and quality of their desired dish.

It is difficult to “press” a tofu, yogurt, or cheese and relieve it of the moisture content without squishing or breaking apart the underlying solid.

The prior art is replete with draining and straining devices for various types of foods. Many are specific to a type of food container (for example, U.S. Pat. No. 5,902,481 teaches a device for draining a standard food can). Some devices serve the purpose of draining larger food stuffs on a multi-component serving tray such as U.S. Pat. No. 7,025,213. Many others are specific to a particular type of food (for example, U.S. Pat. No. 5,139,166 teaches a watermelon tray, and U.S. Pat. No. 4,680,117 teaches a yogurt separator).

More specifically, the yogurt separator mentioned in U.S. Pat. No. 4,680,117 consists of a series of components in flat form that may be assembled to form a yogurt receiving cup. The preferred shape is conical, and the yogurt is poured into the cup and the liquid whey drains through a series of fine mesh screens. This patent does not include a reservoir for the liquid whey, nor does it provide a means to stop the filtration process without transferring the yogurt to a new container.

Many of the prior art make contributions to the overall food draining art; however, they are disadvantageous and typically limited to a specific function. These inventions would fail to enable a person to drain various types of food stuffs to a specific degree, collect the excess moisture, and cover and store the food stuffs with the same device. For example, a person wishing to drain the liquid whey from a yogurt, retain the excess moisture, and store the mixture would incur a large expense accumulating various items to achieve the desired result. Furthermore, this device provides a means for specifying the amount of moisture filtered, and enables the user to stop the filtration process without transferring the food stuffs to a new container.

Thus, there is a present and ongoing need for an improved device to reduce the moisture content of solid foods.

### SUMMARY OF THE INVENTION

An exemplary embodiment of the present invention provides a new food draining device capable of handling various types of food stuffs. The invention includes a cover, tray, center filter, disk screen, collection cup, and sliding latches. Together, these features enable a user to reduce the excess moisture of thickened, coagulated, or curdled food stuffs.

In one representative embodiment, the food stuffs are placed into the tray, and gravity forces the excess moisture through the openings of the tray, a center filter, a disk screen, and into a collection cup. The disk screen is raised by attached slide latches that line up a solid surface with the openings in the tray. This effectively halts the filtration process and enables the user to cleanly remove the collection cup. Following, the remaining food product resides on a solid surface in the tray. A cover may be placed on the tray either during or following the filtration process to store the food product.

In one aspect of the present invention, a draining device comprises a tray forming a basin; drainage holes formed in a bottom portion of the basin; solid portions of the bottom portion disposed in a pattern thereon; a disk screen disposed below the tray; at least one disk screen cam arm extending outward from a side of the disk screen; slots cut in the disk screen, the slots formed in the pattern of the solid portions of the bottom portion of the tray such that when the bottom portion of the tray is aligned with the disk screen, the disk screen blocks the drainage holes in the basin; a collection cup disposed below the disk screen, where fluid passing through the drainage holes and the slots is accumulated in the collection cup; and a sliding latch, interconnecting the tray with the collection cup, wherein the sliding latch is movable at least between a first, closed position, where the bottom portion of the basin is disposed against the disk screen, and a second, open position, where the disk screen is separated from the bottom portion of the basin, thereby allowing fluid to flow to the collection cup.

These and other features, aspects and advantages of the present invention will become better understood with reference to the following drawings, description and claims.

### BRIEF DESCRIPTION OF THE DRAWINGS

FIG. 1 shows an isometric view of an embodiment of the invention in its fully assembled condition (without cover);

FIG. 2 shows an alternate isometric view of the invention (without the cover);

FIG. 3 shows an exploded perspective view of the invention (with the cover);

FIG. 4 shows a top view of the tray, looking down into the tray, without the cover;

FIG. 5A shows a bottom view of the tray, looking up at the tray;

FIG. 6 shows a side view illustrating the tray, cup and latch;

FIG. 7 shows a second side view illustrating the tray, cup and latch;

FIG. 8 shows an isometric view of the collection cup;

FIG. 9 shows a side view of the collection cup with emphasis on the measuring guide;

FIG. 10 shows a top view of the collection cup, looking down into the collection cup;

FIG. 11 shows the latch position indicators and slide guide rails;

FIG. 12 shows an isometric view of the disk screen;

FIG. 13 shows a top view of the disk screen, looking down at the disk screen;

FIG. 14 shows a bottom view of the disk screen;

FIG. 15 shows a side view of the disk screen;

FIG. 16 shows the guide and cam arms that are attached on opposite sides of the disk screen;

FIG. 17 is a second view that shows the guide and cam arms that are attached on opposite sides of the disk screen;

FIG. 18 shows a perspective view of the sliding latch with emphasis on the thumb lobe;

FIG. 19 shows a second perspective view of the sliding latch;

FIG. 19B shows the inside of a sliding latch with the latch cam and intermediate screen arm;

FIG. 20 shows front view of the sliding latch;

FIG. 21 shows the inside of a sliding latch and latch cam surface;

FIG. 22 shows a side view of a sliding latch;

FIG. 23 shows an isometric view of the cover;

FIG. 24 shows a detail of the lift tabs attached on opposite ends of the cover;

FIG. 25 shows an isometric half view of the fully assembled invention without the cover in place;

FIG. 26 shows a cross section of the assembled invention;

FIG. 26B shows a detail of the latch connection with emphasis on positioning of the tray, disk screen, collection cup, and sliding latch;

FIG. 27 shows the connection between tray, disk screen, and a sliding latch;

FIG. 28A shows an initial step in assembling the invention by lowering the disk screen into proper position over the collection cup;

FIG. 28B shows the disk screen being placed into position over the collection cup;

FIG. 29 shows the disk screen in proper positioning over the collection cup;

FIG. 30 shows the center filter being lowered into place on top of the disk screen;

FIG. 31A shows how to attach the tray by aligning the thumb wings with the guide slots of the cup and lowering the tray over the disk screen and filter;

FIG. 31B shows the elements of the device properly aligned; and

FIG. 32 shows a representative of an alternate embodiment with the center filter placed into positioning in between the cover and tray.

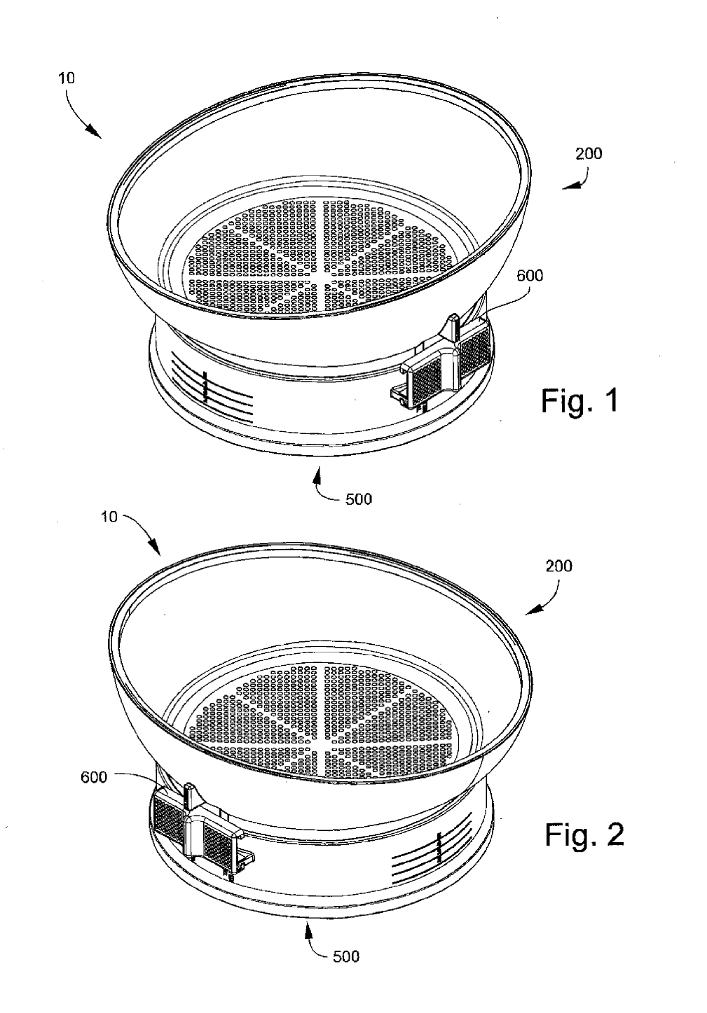

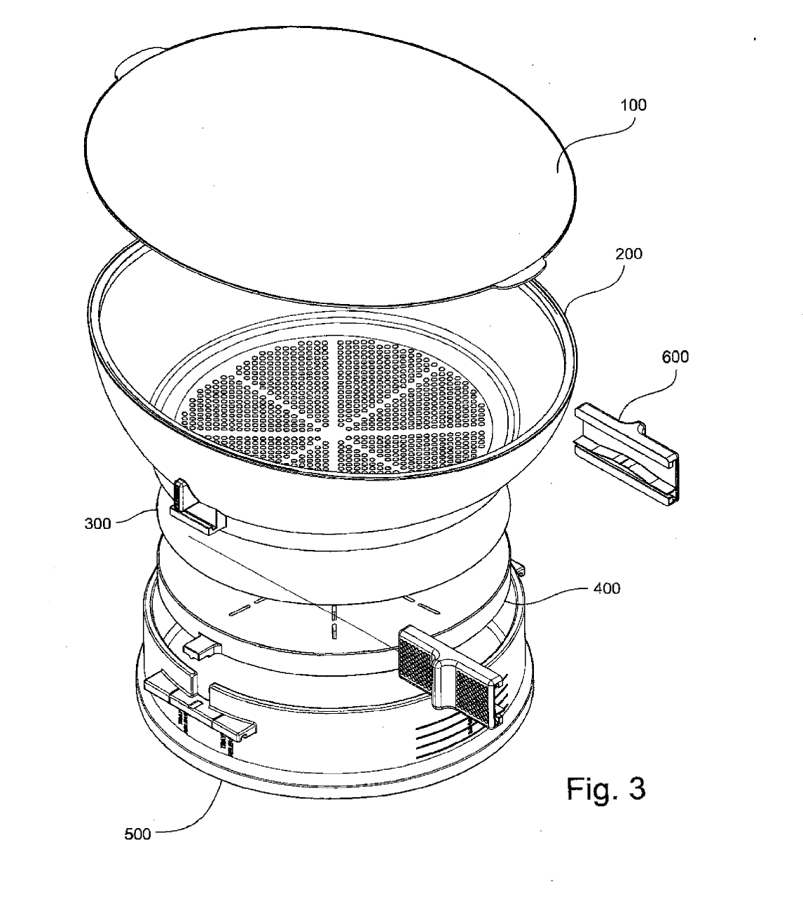

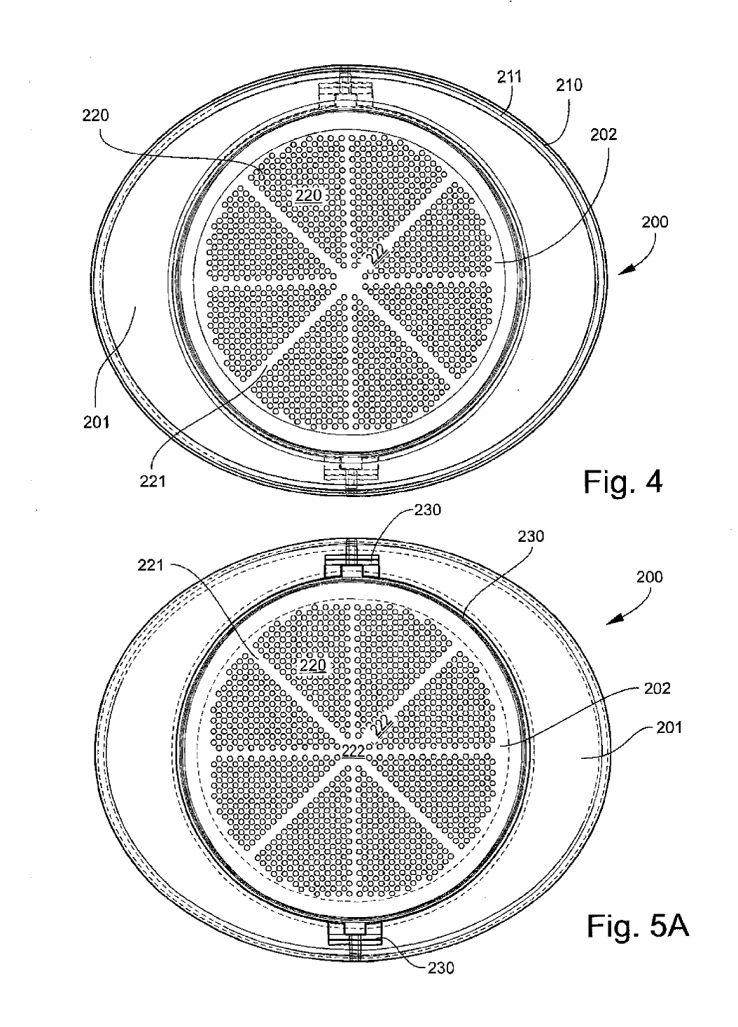

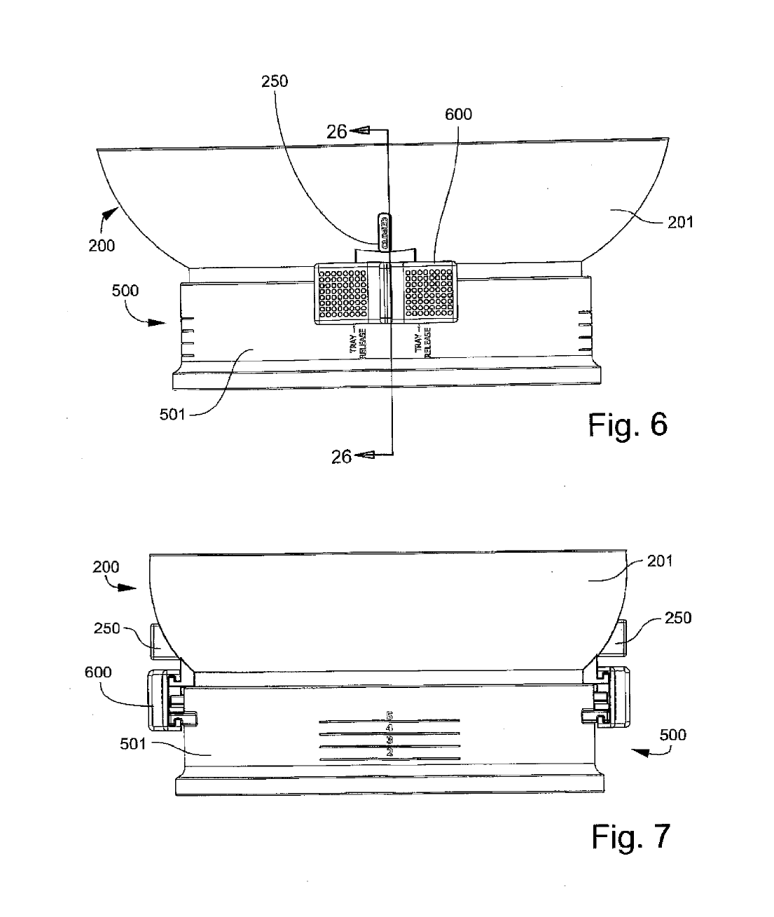

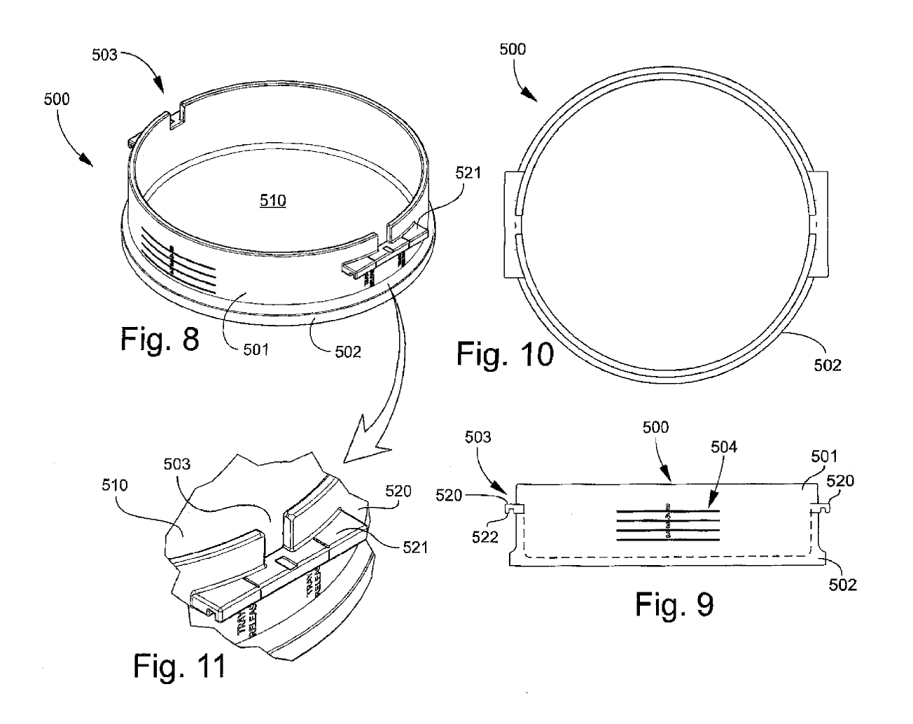

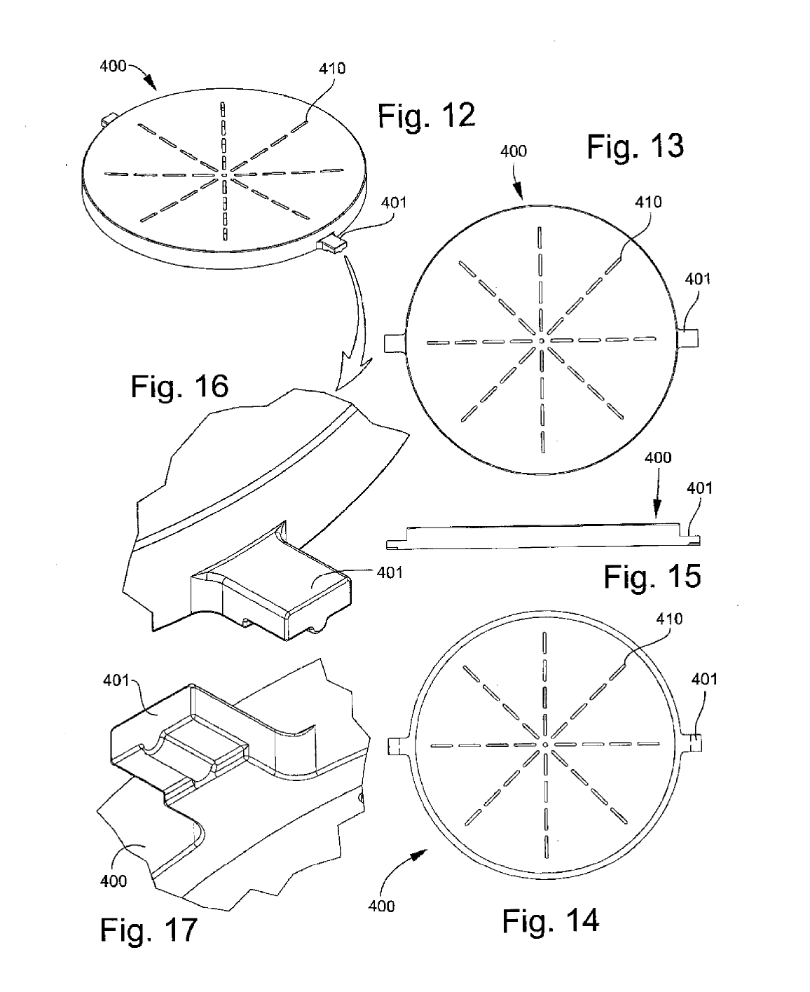

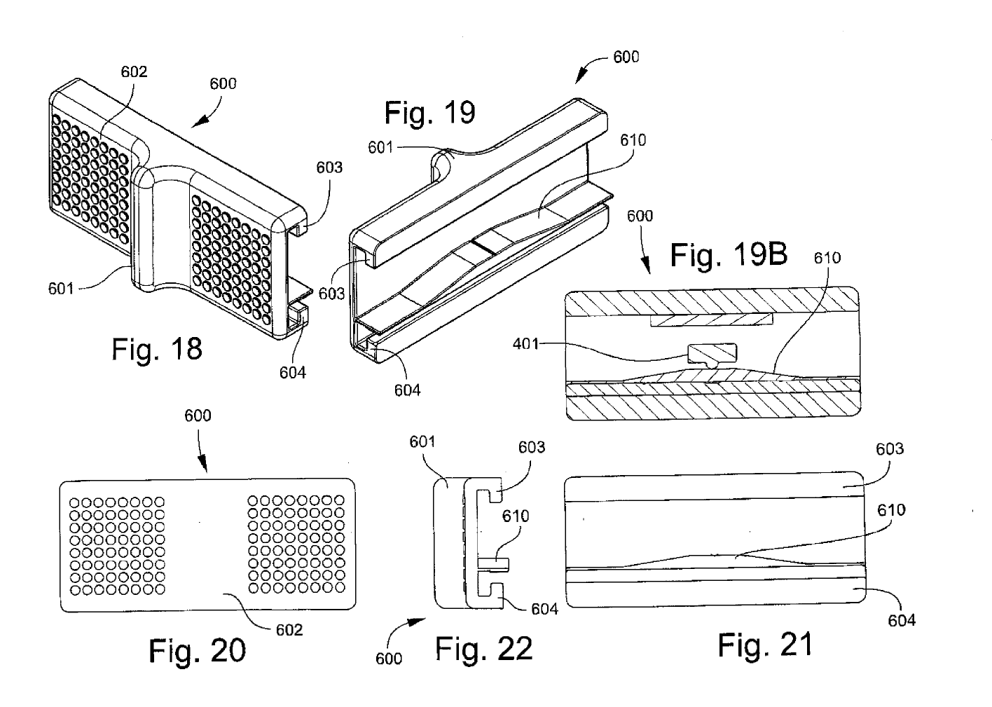

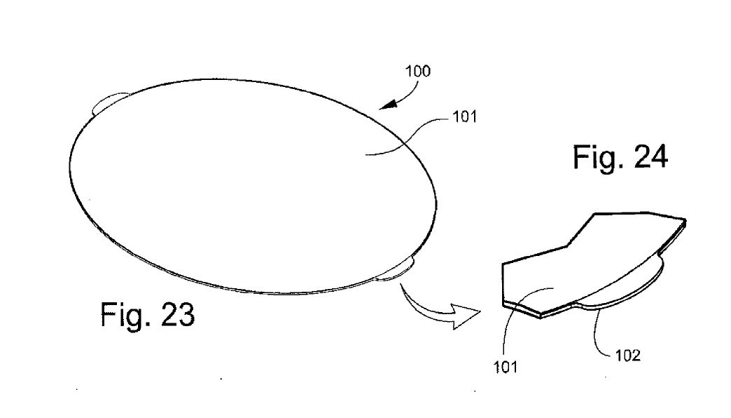

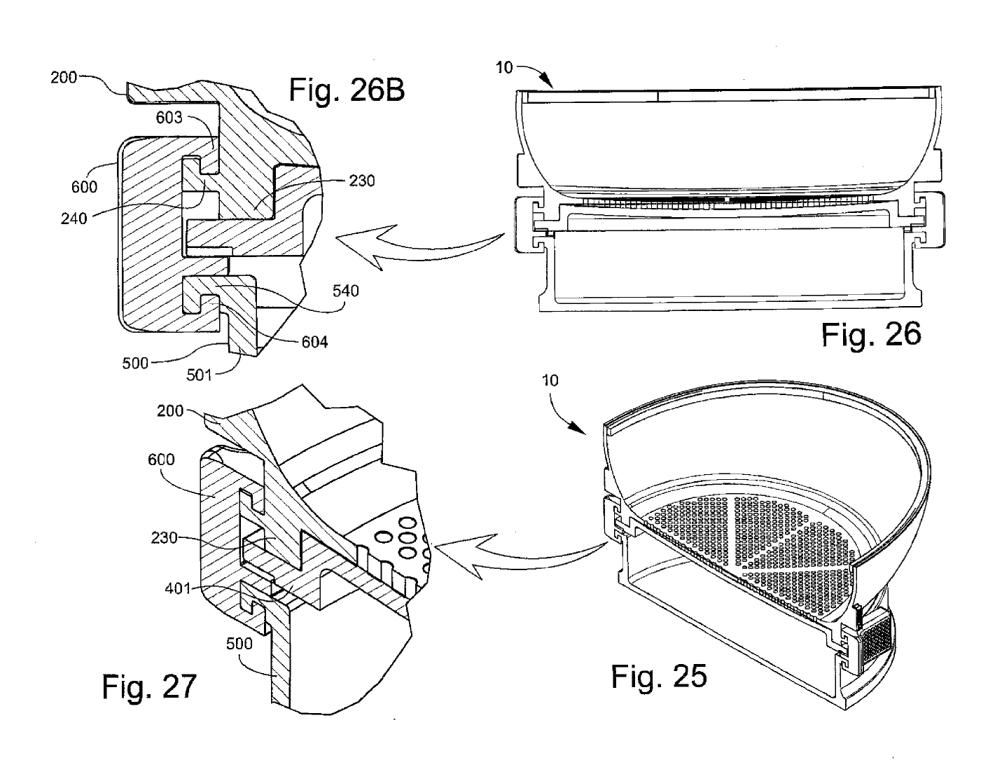

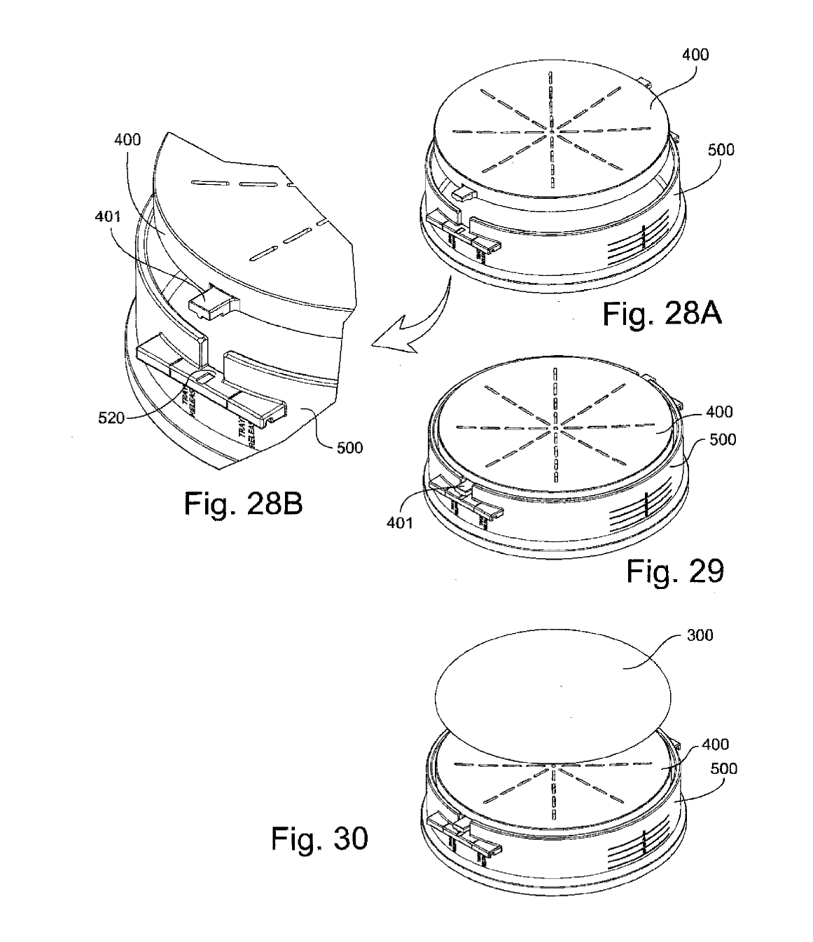

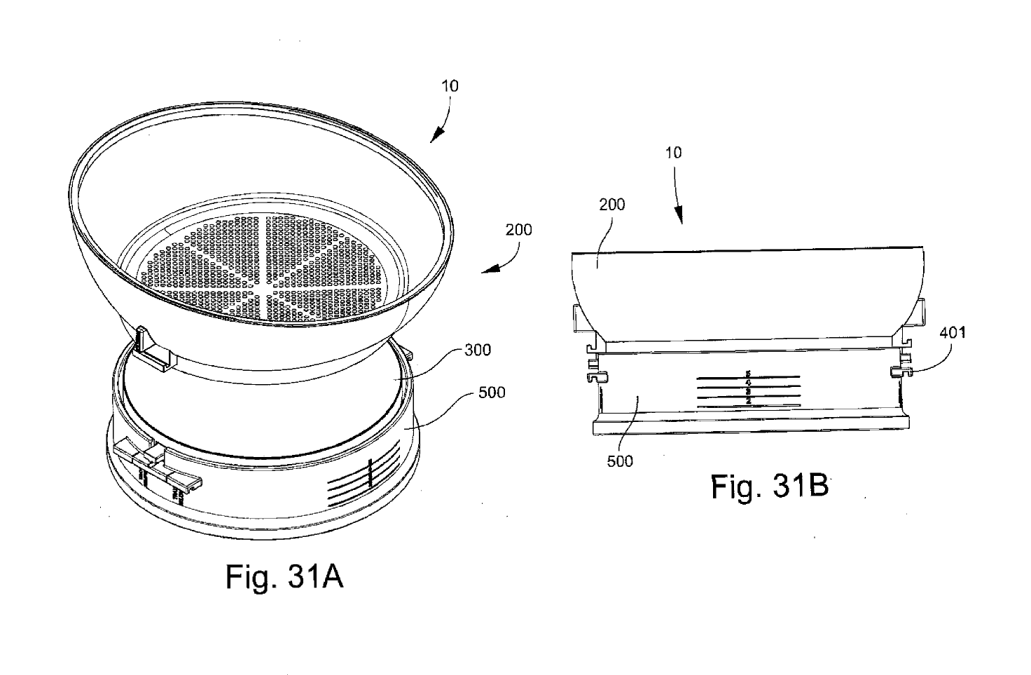

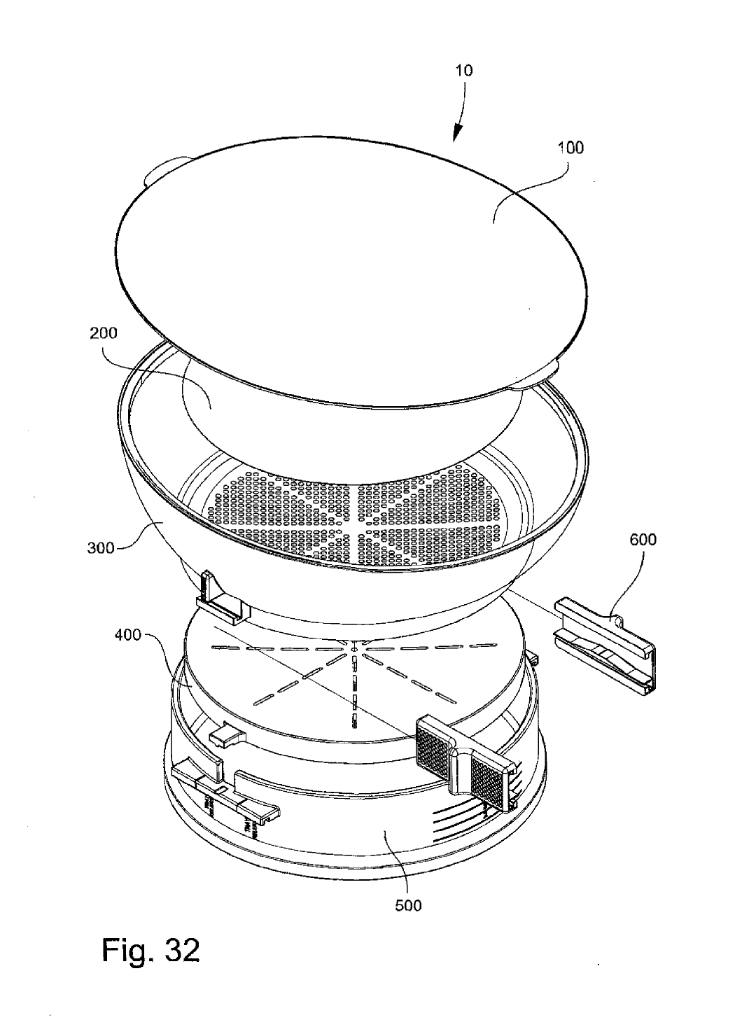

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a multi-component apparatus for reducing the moisture content of thickened, coagulated, or curdled food stuffs. The food stuffs rest upon a slotted tray, and gravity forces the excess moisture through the openings of the tray, a center filter, a disk screen, and into a collection cup. The disk screen has a solid surface that lines up with the openings in the tray and is raised and lowered using attached slide latches, dependent on the latch position. When the latches are positioned to the open position, the fluid is allowed to flow through into the attached collection cup and allows for the collection cup to be removed for draining and complete cleaning. The filter may be inside the tray or between the tray and the disk screen. A cover may be placed on the tray either during or following the filtration process to store the food product.

Embodiments of the present invention provide a device 10 for draining food stuffs. An exploded view of an embodiment of the present invention shows the various components thereof—a cover 100, tray 200, center filter 300, disk screen 400, collection cup 500, and at least one sliding latch 600.

The cover 100 can be formed from a solid surface 101 with at least one, typically two lift tabs 102 at opposite ends of the cover 100. The cover 100 may be shaped to fit within the outer wall of the tray 200.

The tray 200 includes an ovular-shaped basin 201 capable of holding food stuffs. A brim 210 of the tray can include grooves 211 so that the cover 100 may be secured in place on top of the tray 200. The tray 200 can includes a side surface that is solid and a bottom surface 202 that has drainage holes 220.

The drainage holes 220 are dimensioned to support solid food stuffs while permitting drainage, typically of 0.12 centimeters in diameter. It is important that there is a series of solid surface lines 221 beginning at a center point 222 of the tray 200 and typically extending radially outward at approximately 45 degree intervals.

The disk screen 400 is located underneath the tray 200; however, a center filter 300 may be placed in between these two components. The disk screen 400 has at least one cam arm 401 that extends outward from the side of the disk screen 400. Feet 230 on the tray 200 rest on top of the disk screen cam arm 401 and hold the disk screen 400 securely in place on top of the collection cup 500.

Solid surface lines 221 located along the bottom surface of the tray 200 line up with the slots 410 of the disk screen 400. When the bottom surface 202 of the tray 200 is properly aligned with the disk screen 400, the bottom surface 202 of the tray 200 may act as a solid container when locked into place through use of a sliding latch 600.

The collection cup 500 is located at the base of the device 10 according to the present invention. On a side wall 501 of the collection cup, there is a measuring guide 504 to display to users how much excess moisture is currently contained within a collection cup basin 510. The collection cup basin 510 is typically of a smaller diameter than the cup base 502 that extends at the bottom of the side wall of the collection cup 501 to ensure stability and support of the entire structure.

On opposite ends of the side wall 501 of the collection cup 500 are two guide slots 503 that enable the cam arms 401 of the disk screen 400 to fit securely into its place above the collection cup 500. Both of the cam arms 401 are aligned with the guide slots 503 of the collection cup 500, and the disk screen 400 will then rest upon a cup shoulder 520 that extends outward from the collection cup side wall 501.

At least one sliding latch 600 is located on opposite ends of the device according to the present invention, and these essentially hold the entire structure together. Two upper latch joints 240 extend outward from the feet 230 of the tray 200 and are shaped to permit coupling of the top latch connections 603 to upper latch joints 240. Two lower latch joints 540 extend outward from the outer wall 501 of the collection cup 500 and are shaped to permit coupling of the lower latch connections 604 to the lower latch joints 540. The upper and lower latch joints 240 and 540 are essentially rails on which the latches 600 may slide.

A thumb lobe 601 is located on the outer side 602 of both sliding latches 600 to ease the user in sliding the latches. The position of the sliding latches 600 is marked on the collection cup shoulders 520 by two latch position indicators 521. These display to the user whether the latches are in an “open” or “closed” position. By sliding the latches 600 into the “closed position,” the latch cam 610 becomes centered over an intermediate screen arm 611. This raises the disk screen 400 and aligns the slots 410 in the disk screen 400 to the solid surface lines 221 of the tray 200.

Latch position indicators 521 are located on the collection cup shoulders 520 and on opposite end of the tray 200 thumb wings 250. These display whether the user has moved the latches 600 into an “open” or a “closed” position.

In another representative embodiment of a device 11, the user may elect to place the center filter 300 in between the tray 200 and cover 100 should that better suit their desired purpose. Ultimately, the center filter 300 is an optional component of the device.

The device 10 is a multi-component apparatus for reducing the moisture content of lightly thick, semi thick, or curdled food product. The food product rests within a deep tray/bowl 200 designed with an array of circular perforations 220 located on its bottom side surface 202. Through a process of time and gravity, excess moisture contained in the food product moves towards the bottom of the tray 200. The exit of the fluid will be filtered through a paper or cloth type disc filter 300 located over the perforations 220 or under the slots 410 residing on the topside of the tray disk screen 400. The fluid will exit through the circular perforations 220 of the tray 200 when the position of the latches 600 changes along the guide rail to the respective position indicators marked on the tray's thumb wing 250 and outside wall of the collection cup 500. The cams 610 designed on the inner walls of the side latches 600 will raise or lower the tray disk screen 400 to allow the solid portion of the disc screen 400 to contact the perforation openings 220 or to create a gap between the mating surfaces to allow fluid to pass through the tray perforations 220 and the slot openings 410 of the disc screen 400. The action allows an open or close position dependent on the latch position. When the latches 600 are positioned to the open position, the fluid is allowed to flow through into the attached collection cup 500. The latches 600 are designed to follow linearly along slotted rails on the collection cup ears 521. V-grooves traversing the rails act as position indicators when the rounded lobes of the latch engage with the grooves, in addition to the corresponding markings on the tray 200 and latch 600. Moving the latches 600 to a “Tray Release” position allows for the collection cup 500 to be removed for draining and complete cleaning. The tray bottom ring profile allows it to lay on a flat surface while the cup 500 is removed. Installation of the cup 500 is in reverse order. A cover 100 is placed on the tray 200 during the draining process and protects the product from other foods and their odors during refrigeration and also after the process to store the food product.

It should be understood, of course, that the foregoing relates to exemplary embodiments of the invention and that modifications may be made without departing from the spirit and scope of the invention as set forth in the following claims.

What is claimed is:

1. A draining device comprising:
a tray forming a basin;
drainage holes formed in a bottom portion of the basin;
solid portions of the bottom portion disposed in a pattern thereon;
a disk screen disposed below the tray;
at least two disk screen cam arm extending outward from a side of the disk screen;
slots cut in the disk screen, the slots formed in the pattern of the solid portions of the bottom portion of the tray such that when the bottom portion of the tray is aligned with the disk screen, the disk screen blocks the drainage holes in the basin; and
a collection cup disposed below the disk screen, where fluid passing through the drainage holes and the slots is accumulated in the collection cup; and
a latch, interconnecting the tray with the collection cup, wherein the sliding latch is movable at least between a first, closed position, where the bottom portion of the basin is disposed against the disk screen, and a second, open position, where the disk screen is separated from the bottom portion of the basin, thereby allowing fluid to flow to the collection cup.

2. The draining device of claim 1, further comprising a cover having at least one lift tab, the cover capable of covering the tray.

3. The draining device of claim 2, further comprising grooves in a brim of the tray for fitting the cover therein.

4. The draining device of claim 1, wherein the pattern begins at a center point of the bottom portion and extends radially outward at approximately 45 degree intervals.

5. The draining device of claim 1, further comprising a center filter disposed either between the tray and the disk screen or positioned over the bottom portion of the tray, inside the tray.

6. The draining device of claim 1, further feet on the tray, the feet resting on top of the disk screen cam arm and holding the disk screen in place on top of the collection cup.

7. The draining device of claim 1, further comprising guide slots on the collection cup permitting the disk screen cam arms to fit therein.

8. The draining device of claim 1, further comprising:
upper latch joints extending outward from the tray; and
lower latch joints extending outward from an outer wall of the collection cup, wherein
the sliding latch couples the upper latch joints to the lower latch joints.

9. The draining device of claim 1, further comprising latching position indicators to show whether the device is in the first, closed position, or in the second, open position.

10. The draining device of claim 1, further comprising an intermediate screen arm in the sliding latch, the intermediate screen arm raising the disk screen to the tray.
